(19) United States
(12) Patent Application Publication
(10) Pub. No.: US 2013/0311633 A1
(43) Pub. Date: Nov. 21, 2013

(54) CONTENT SERVER

(71) Applicant: Tom Barnett, Ashurst (GB)

(72) Inventor: Tom Barnett, Ashurst (GB)

(21) Appl. No.: 13/817,470

(22) PCT Filed: Aug. 8, 2011
(86) PCT No.: PCT/GB2011/001186

§ 371 Date: Aug. 2, 2013

(30) Foreign Application Priority Data
Aug. 18, 2010 (GB) 1013855.0

(51) Int. Cl. H04L 29/08

(52) U.S. Cl. CPC H04L 67/02
USPC 709/223

(57) ABSTRACT

A content server for serving content items for inclusion in a web page. The content server comprises a web interface, a content store, a serve log and a decision engine. The content store stores a plurality of content items, each content item having associated with it a desired number of impressions for a predetermined time period. The serve log stores, for each content item, the most recent time which it was served by the content server. The decision engine is arranged to calculate, for each content item, a minimum time period for the content item based on its associated desired quantity of impressions and the predetermined time period, and to select a content item for transmission by the web interface from amongst the content items for which the duration between the current time and the time stored in the serve log exceeds the minimum time period calculated for the content item.

The present invention concerns a content server for serving content items for inclusion in a web page. The invention is particularly, but not exclusively, appropriate for use with an “ad server”, that is a server that provides advertisements for inclusion in web pages.

### BACKGROUND OF THE INVENTION

A known system for providing web pages is shown in FIG. 1. The system 1 comprises a personal computer 11, a web server 12, and a content server 13, all of which are able to communicate over the internet 10.

The personal computer 11 has installed on it a web browser application which is able to retrieve and display “web pages” obtained over the internet 10. Web pages are commonly defined by means of data files in the HyperText Markup Language (HTML).

The web server 12 has installed on it web server software, which is able to provide (amongst other things) HTML data files that define web pages. A user of the personal computer 11 can request a web page from the web server 12 using a Uniform resource Locator (URL), or “web address”, associated with the web server 12, which may for example of the form http://webserver.com/page.html. This is interpreted as a request for the HTML data file “page.html”, from the web server known to the internet 10 as “webserver.com”, which in this example is the web server 12.

The web address may be entered directly into the web browser by the user, or for example a web page the user is currently viewing may contain a hyperlink associated with a web address, which can be clicked by the user to request the web page with that web address. To retrieve a web page, the personal computer 11 sends a request for the HTML data file with the desired web address to the internet 10; the internet 10 then relays that request to the web server 12, which in response returns the data file. The HTML data file is then relayed by the internet 10 back to the personal computer 11, and displayed by the web browser.

An example web page defined by a HTML data file page.html as seen when viewed on the web browser is shown in FIG. 2. The web page 20 comprises text 21, which is explicitly contained in the underlying HTML data file page.html. The web page 20 also comprises a picture 22. However, unlike the text 21, the picture 22 is not explicitly contained in the underlying HTML data file page.html. Rather, the HTML data file page.html contains a reference to a graphics file that is used to generate the picture. The reference may for example be of the form http://contentserver.com/picture.jpg, which is interpreted as a request for the graphics file “picture.jpg”, from the web server known to the internet 10 as “contentserver.com”. When displaying the web page 20 as defined by the HTML data file page.html, the web browser makes a further request to the internet 10 for the required graphics file picture.jpg at address contentserver.com; the internet 10 relays the request to the content server 13, which returns the graphics file; the graphics file is then relayed by the internet 10 back to the personal computer 11, which displays it as part of the web page 20.

In addition or alternatively to a graphics file, other content may be provided. For example, a web address may be provided along with the graphics file, and the web page 20 arranged to go to that web address when the picture 22 is clicked by the user. Further, text to be displayed, or code to be executed, might be provided along with the graphics file, or an “applet” file might be provided instead of a graphics file, to give just some examples. It is common for code to be included that collects data from the personal computer 11, for example details of the web browser being used, data stored in “cookies” used by the web browser, and the like.

As can be seen, a web page obtained from a first source, in the above example the web server 12, may include content from a second source, in the above example the content server 13. There are many applications for which such an arrangement may be desirable. A common application is the supply of advertisements in web pages, whereby the provider of the web page 20 allows advertisements to be displayed as part of their web page, usually in return for payment.

When a content server 13 is used to provide such advertisements, it is commonly known as an “ad server”. The advertisements may be provided as graphics files to be included in the web page 20, as described above. In this case, the content server 13 will have a store of graphics files corresponding to different advertisements that it can provide. When the content server 13 receives a request for an advertisement, it returns one of the graphics file from the store, corresponding to the particular advertisement it wishes to be displayed on that occasion. A known process for selecting the particular advertisement to be displayed is now described.

The different advertisements provided by the content server 13 are separated into distinct sets, which correspond to different advertising “campaigns”. So, for example, a set of advertisements making up a campaign X may be for a particular product sold by a particular company. The company will have indicated a desired number of “impressions” for campaign X; an “impression” is an occurrence of an advertisement being displayed in a web browser on a user's computer. So, for example, they may indicate that they wish campaign X to have 100,000 impressions a day; in other words, they want the advertisements in the campaign to be displayed in user's web browsers 100,000 times over a day.

In a first step, the required number of impressions for each advertisement in the campaign is calculated. This is usually simply a case of dividing the number of impressions for the campaign as a whole by the number of advertisements in the campaign; so if there are 5 advertisements in campaign X, each would require 20,000 impressions. However, the impressions for the campaign as a whole can be allocated irregularly amongst the advertisements, if it is desired to that certain advertisements in a campaign are displayed more often than others. A campaign may also have a “click-through” target, in addition to the desired number of impressions; this is a target for the number of advertisements that are clicked on by a user to go to the web address associated with the advertisement. If it is found that advertisements are being clicked on less (or more) often than expected, the number of impressions for the advertisements in the campaign may be increased (or decreased) to take account of that.

This first step is repeated for all campaigns covered by the content server 13, resulting in a number of impressions for each advertisement to be provided by the content server 13. These numbers of impressions are used to assign a priority weight for each advertisement; the higher the number of impressions, the higher priority weight assigned to the advertisement.

In operation, when a request for an advertisement is sent to the content server 13, it uses a standard pseudorandom algorithm to select an advertisement to return. However, the priority weights assigned to the advertisements are used to vary the probability that particular advertisements will be selected. In other words, an advertisement with a higher priority weight will have a higher probability of being selected, while an advertisement with a lower priority weight will have a lower probability. In this way, the content server 13 attempts to provide the required number of impressions for each advertisement, and consequently for each campaign.

However, there are various problems associated with this method of selecting advertisements, some of which are now discussed.

It is often desirable to set limitations on circumstances under which the advertisements in the campaign are displayed. As discussed above, the content server 13 may be able to collect data from the personal computer 11 of the user, and may be able to derive a profile from the data for the user. For example, the IP address of the personal computer 11 will indicate the country in which the user is based, and cookies stored on the computer may indicate other websites the user has visited, items they have purchased, and data they have provided online. As an example, the content server 13 may be able to derive a profile of the user as male, based in the UK, with an interest in cars. A campaign may have a limitation that its advertisements are to be displayed only to users who fit such a profile, for example.

In such a case, the advertisement selected by the content server 13 will be selected from amongst only those advertisements for which the limitations are satisfied. However, as the priority weightings are calculated on the basis of all possible advertisements, the priority weightings will not give the desired behaviour in this case. For example, suppose the content server 13 can serve advertisements from the following campaigns as shown in Table 1.

TABLE 1

| Campaign | Impressions | Priority weighting |
|---|---|---|
| A | 400,000 | 0.4 |
| B | 500,000 | 0.5 |
| C | 100,000 | 0.1 |

The total number of impressions required is 1,000,000, and so the campaigns are assigned the priority weightings shown in the table above. Suppose further that the content server 13 receives 1,000,000 requests spread evenly over a day. By selecting the advertisements from the campaigns according to their assigned priority weightings, the desired impressions will be provided, spread evenly over the day.

However, now suppose that the campaigns have the country limitations shown in Table 2.

TABLE 2

| Campaign | Country limitation |
|---|---|
| A | Any country |
| B | USA only |
| C | UK only |

Suppose further that 800,000 of the daily requests come from users in the USA, and the remaining 200,000 come from the UK. (Such variations occur due to the different populations in different countries, amongst other things.)

When a request comes from the USA, an advertisement will be selected from either campaign A or campaign B (as campaign C is limited to the UK only). These campaigns have respective priority weights 0.4 and 0.5, and so for requests coming from the USA around 355,556 advertisements from campaign A will be selected, and around 444,444 from campaign B. In contrast, when a request comes from the UK, an advertisement will be selected from either campaign A or campaign C (as campaign B is limited to the USA only); these campaigns have respective priority weights 0.4 and 0.1, and so for requests coming from the UK around 160,000 advertisements from campaign A will be requested, and around 40,000 from campaign C. Over the day, this gives the actual impressions for each campaign shown in Table 3, which it can be seen is not in line with the desired impressions. This is despite the fact that there are clearly sufficient requests over the day, satisfying the requirements of the different campaigns, to allow the desired impressions to be provided.

TABLE 3

| Campaign | Desired impressions | Actual impressions |
|---|---|---|
| A | 400,000 | 515,556 |
| B | 500,000 | 444,444 |
| C | 100,000 | 40,000 |

Another problem with this method is that it is not able to take into account satisfactorily factors relating to campaigns other than the desired number of impressions. For example, two campaigns may have the same desired number of impressions, but one may be more profitable per impression to the operator of the content server 13 than the other. Consequently, it would be desirable in certain circumstances, particularly when it will not be possible to provide the full desired number of impressions for both campaigns, for advertisements from the more profitable campaign to be selected more frequently than advertisements from the less profitable campaign. Using the present method, this can be done only by modifying the required number of impressions for the advertisements in each campaign, so as to modify their priority weights. However, this can lead to too many or too few impressions being provided for each campaign overall, which is clearly undesirable.

US 2007/0299682 A1 (Roth et al), published 27 Dec. 2007, discloses a system that determines an advertisement to place on a web page in response to a request for the web page by a browser. The system receives one or more bids, each bid being associated with an advertisement, selects one of the bids, and places the advertisement associated with the selected bid on the web page. This type of system is commonly known as “real-time bidding” system, and differs from the systems of the type of present invention in that it does not itself have content items which it requires to serve, but rather offers impressions to other parties in which their content items can be served.

The present invention seeks to solve or mitigate some or all of the above-mentioned problems. Alternatively or additionally, the present invention seeks to provide an improved content server and method of serving content items.

While the invention is particularly suitable in the context of serving advertisements for inclusion in web pages, it will be appreciated that it is applicable to situations in which other types of content items are to be provided from a set. For example, the present invention could be applied to the serving of pictures, jokes, games, quiz questions or any other content that might be included in a web page.

### SUMMARY OF THE INVENTION

In accordance with a first aspect of the invention there is provided a content server for serving content items for inclusion in a web page, comprising:

a web interface arranged to receive requests for content items and to transmit content items in response to such requests;

a content store arranged to store a plurality of content items, each content item having associated with it a desired number of impressions for a predetermined time period;

a serve log arranged to store, for each content item, the most recent time which it was served by the content server;

a decision engine arranged, in response to a request for content received by the web interface, to transmit a content item from the plurality of content of items via the web interface;

wherein the decision engine is arranged to calculate, for each content item, a minimum time period for the content item based on its associated desired quantity of impressions and the predetermined time period;

and wherein the decision engine is further arranged to select the content item for transmission by the web interface from amongst the content items for which the duration between the current time and the time stored in the serve log exceeds the minimum time period calculated for the content item.

Thus, the content item to be served is selected from amongst those which have not been served for greater than their minimum time period. As the minimum time period is calculated based on the number of impressions required, this ensures that a content item is not served more often than is required. However, the choice of which content item to serve from amongst those for which the minimum time period has been exceeded can then be made based on other factors. Examples of methods for deciding include selecting a content item at random, selecting the content item which was served the least recently (i.e. the “oldest” content item), selecting the most profitable content item, or any other suitable method could be used. As the method of selecting the content item is not implemented by adjusting the minimum time period or the desired number of impressions, this allows the method to be used without disadvantageously affecting the number of impressions made over the predetermined time period.

Preferably, the decision engine is arranged to periodically recalculate the minimum time periods for the content items. This allows content items to be selected after a lesser or greater time period if the number of times they have been served so far is lesser or greater than expected.

Advantageously, the minimum time periods are calculated for a plurality of intervals in the predetermined time period. For example, the minimum time period may be calculated for each hour within a day. This allows variations in the number impressions available over the predetermined time period to be taken into account.

Advantageously, the minimum time periods are calculated based on historical data of available impressions.

Preferably, the web interface is arranged to obtain data indicating the type of a request for content items, and the content items have associated with them limitations on the types of request for which they will be selected. This allows content items to be targeted at particular types of requester. Preferably, the minimum time periods are based on the limitations associated with the content items.

The decision engine may be further arranged to select content items for transmission by the web interface from amongst content items with no associated minimum time period. This allows the content server to serve “default” content items if no content items have exceeded their minimum time period, for example.

Advantageously, the plurality of content items includes video clips, and the desired number of impressions associated with the video clips is calculated based on their duration. This allows a campaign consisting of video clips to have specified a desired total “play time” to be specified, for example; in other words, the desired combined duration of video clips served can be specified. The desired number of impressions is then calculated based on the durations of the video clips so that it gives the desired total play time. By “video clip” is meant any piece of video data, whether real-life, animated or any other set of moving images.

The web interface may be arranged to receive offers of impressions from a remote system, and the decision engine arranged to make a bid for an impression via the web interface, and to transmit the selected content item via the web interface when the remote system indicates that the bid has been successful. In this way, the content server can provide content items for impressions offered for bidding by a third party system, as well or instead of providing content items for impressions where no bidding is required.

In accordance with a second aspect of the invention there is provided a method of serving content items for inclusion in a web page from a plurality of items, each content item having associated with it a desired number of impressions for a predetermined time period, comprising the steps of:

for each content item, calculating a minimum time period for the content item based on its associated desired quantity of impressions and the predetermined time period;

in response to a request for a content item, selecting a content item from the plurality of content items;

serving the selected content item;

recording the time at which the content item was served;

wherein the content item is selected from amongst the content items for which the duration between the current time and the recorded time exceeds the minimum time period calculated for the content item.

Preferably, the minimum time period is periodically recalculated. Advantageously, the minimum time periods are calculated for a plurality of intervals in the predetermined time period. Advantageously, the minimum time periods are calculated based on historical data of available impressions. Preferably, data indicating the type of the request is received with the request, and the content items have associated with them limitations on the types of request for which they will be selected. Preferably, the minimum time periods are based on the limitations associated with the content items. The content item may be further selected from amongst content items with no associated minimum time period.

Advantageously, the plurality of content items includes video clips, and the desired number of impressions associated with the video clips is calculated based on their duration.

The method may further comprise the steps of:

receiving an offer of an impression from a remote system;

sending a bid for the impression to the remote system. If the bid is successful the remote system will then send a request for the content item for inclusion in the impression.

In accordance with a third aspect of the invention there is provided a computer program product arranged, when executed on a server, to provide a content server as described above.

In accordance with a fourth aspect of the invention there is provided a computer program product arranged, when executed, to perform the steps of any of the methods described above.

It will of course be appreciated that features described in relation to one aspect of the present invention may be incorporated into other aspects of the present invention. For example, the method of the invention may incorporate any of the features described with reference to the apparatus of the invention and vice versa.

### DESCRIPTION OF THE DRAWINGS

Embodiments of the present invention will now be described, by way of example only, with reference to the accompanying figures of which:

FIG. 1 is a schematic diagram of a known system for providing web pages;

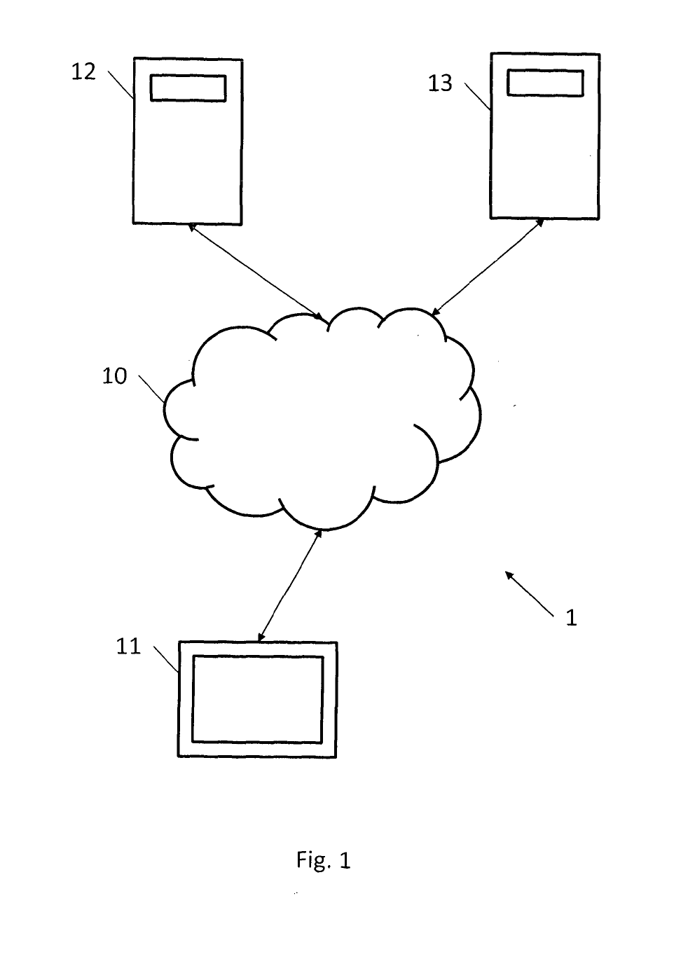

FIG. 2 is a schematic diagram of a web page;

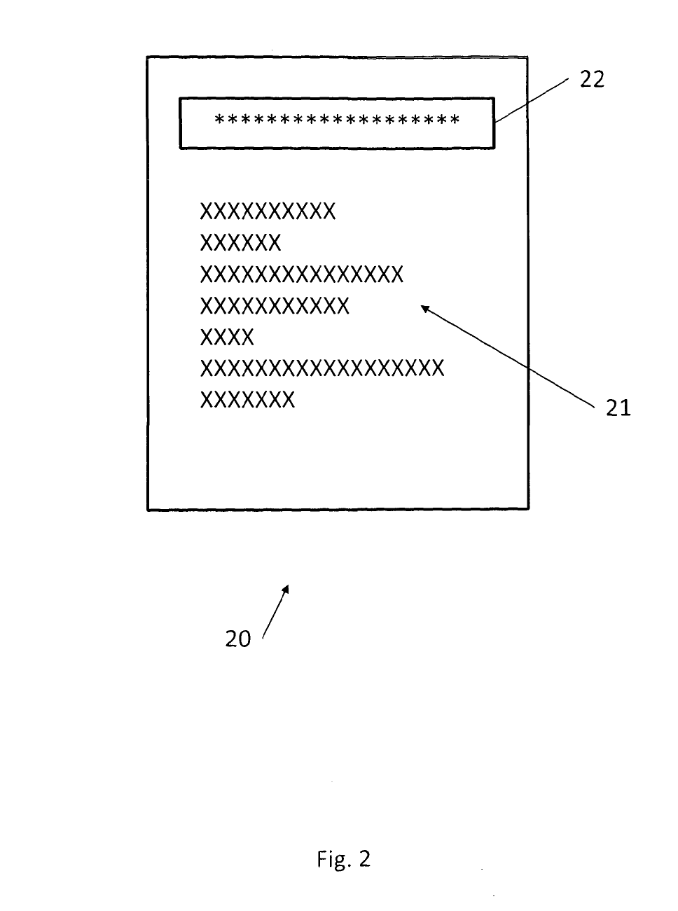

FIG. 3 is a schematic diagram of a content server in accordance with a first embodiment of the present invention;

FIG. 4 is a flow chart showing the behaviour of the content server when a new campaign is added;

FIG. 5 is a flow chart showing the operation of the content server when in use.

### DETAILED DESCRIPTION

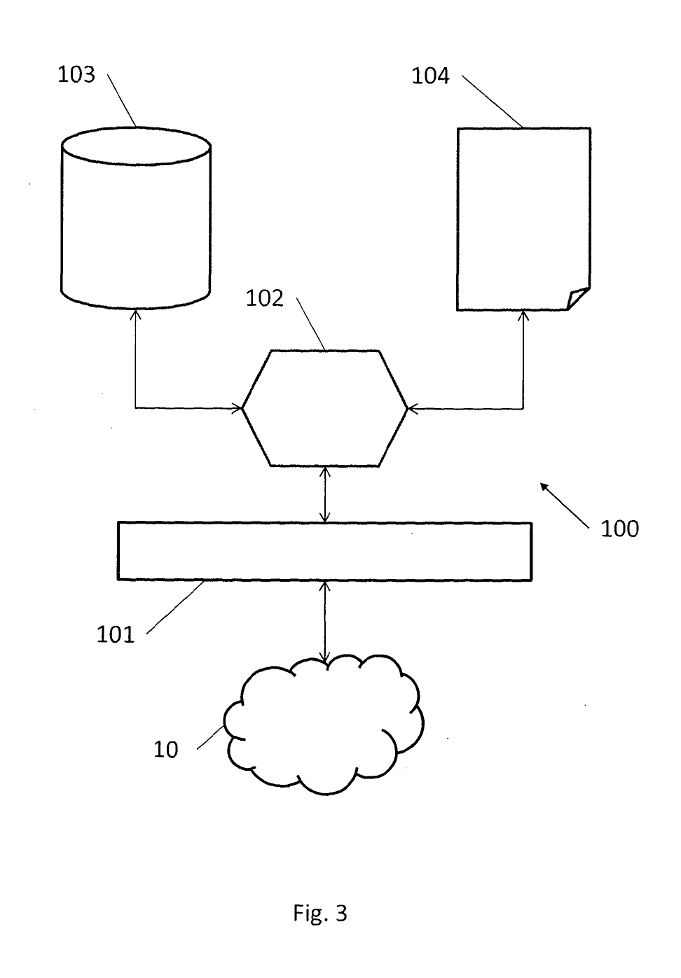

A content server in accordance with a first embodiment of the present invention is shown in FIG. 3. The content server 100, which in this embodiment is an ad server, comprises a web interface 101, which is able to communicate via the internet 10. The web interface 101 is connected to a decision engine 102. The decision engine 102 is further connected to a content store 103, which stores a plurality of content items, and a serve log 104, which stores the most recent time at which a content item stored in the content store 103 was served by the content server 100.

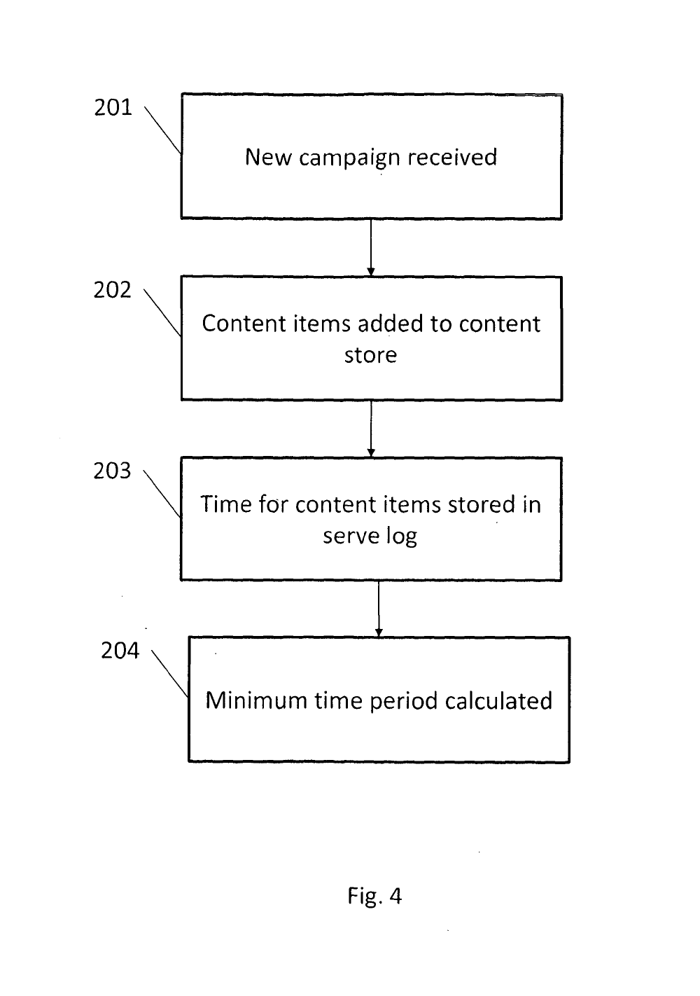

The operation of the content server 100 when a new campaign is added is shown in FIG. 4. This is the same process that will occur when the content server 100 is initialised.

In a first step, new content items (for example graphics files) for the advertisements for a new campaign are received by the content server (step 201). The content items are added to the content store 103 (step 202). The campaign will also have limitations on the types of user for which it is to be used, as discussed above; for example, the advertisements in the campaign may be for display to users who are male and from the UK only. It may be possible to identify the location of a user more precisely, for example from address data they have entered into websites on prior occasions, which may enable their exact postcode to be identified. Limitations may be based on other details about the user, such as available historic data about their web usage patterns, the type of web browser they are using, and so on. Limitations may also be based on the context in which the content will be used, such as content of the web page in which the content item is to be displayed, keywords on the web page or in its URL, the time of year, time of day, and so on. Generally speaking, limitations can be based on any available information about the user who will see the content item and the context in which they will see it, or indeed any other available data which may be considered relevant.

The details of the limitations corresponding to each content item are also stored content store 103.

For each content item stored in the content store 103, a record is created in the serve log 104, storing the current time (step 203). In alternative embodiments, a blank record only is created at the moment when a new content item is added to the content store.

The campaign will have a desired number of daily impressions, and using this a minimum time period is calculated for each content item, and the minimum time period is stored with the content item in the content store 103 (step 204). The minimum time period is calculated by dividing the length of time over which the impressions are to be delivered (so in the present case a day), by the number of impressions required. For example, if 100,000 impressions are required over a day, this gives a minimum time period of 0.864 seconds. In alternative embodiments, further adjustments may be made to the minimum time period; for example, it might be reduced by 10% and rounded down to the nearest hundredth of a second, to give a minimum time period of 0.77 seconds.

In a particularly advantageous embodiment, a campaign includes video clips as content items. The video clips will of course each have a particular duration. The campaign can then have a desired total “play time”, in other words a desired combined duration of the video clips served for the campaign. The desired number of impressions for the campaign is then calculated based on the durations of the video clips, so as to give the desired total play time. For example, a campaign consisting of video clips with a duration of 10 seconds, and having a total play time of 1,000,000 seconds, would have a desired number of impressions of 100,000. This is then used to calculate the minimum time period as described above.

For a campaign consisting of video clips of different durations, the number of impressions may be calculated based on the duration of the video clips so that number of times the video clips are shown is in a certain ratio, or so that the overall duration of the video clips shown is in a certain ratio, or according to any other suitable calculation. So for example, a campaign with a video clip with a duration of 5 seconds and a video clip of 10 seconds might specify that each video clip is shown the same number of times. Alternatively, the campaign might specify that each video clip gets the same amount of play time, with the result that the 5 second video clip has twice the desired number of impressions as the 10 second video clip.

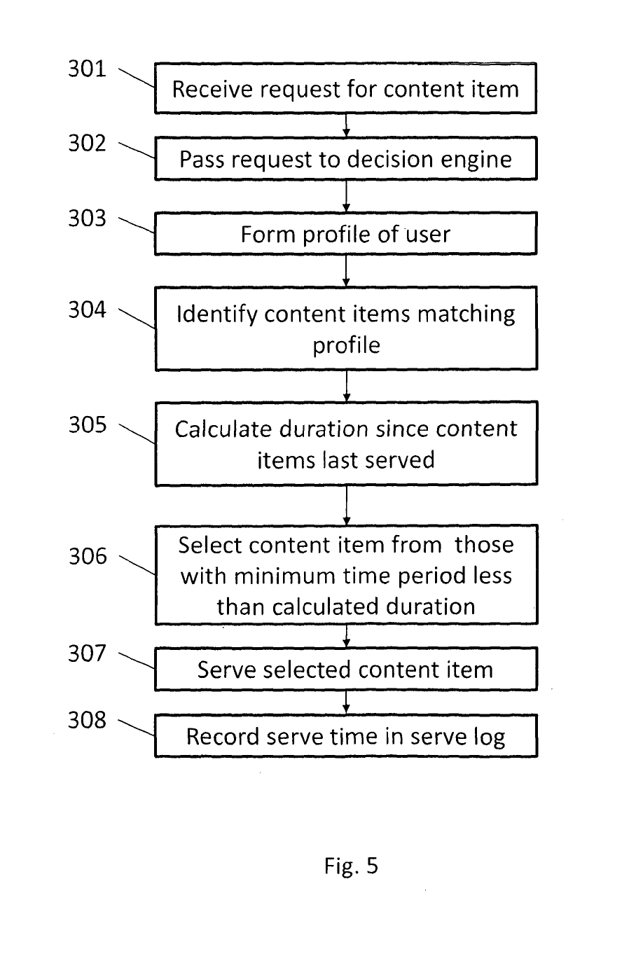

The operation of the content server when in use is shown in FIG. 5. First, a request for a content item is received from the internet 10 by the web interface 101 (step 301). The request may include data collected from the personal computer that made the request. The web interface passes the request and data to the decision engine 102 (step 302). The decision engine 102 then uses that data to determine a profile of the user of the personal computer, as described in detail above.

Next, the decision engine 102 identifies the content items in the content store 103 whose limitations are satisfied by the determined profile of the user (step 304). For each of those content items, the time the content item was last served (or, if the content item has not yet been served, the time the content item was added to the content server) is retrieved from the record in the serve log 104 for the content item, and the difference between that time and the current time is calculated, to give the duration since the content item was last served by the content server 100 (step 305). The content items for which the calculated duration is greater than the minimum time period for the content item (as stored in the content store 103 in step 204) are then identified, and one of these content items is selected (step 306). The content item may be selected using a variety of methods, for example at random. Methods for selecting the content item according to alternative embodiments of the invention are discussed in more detail below.

The selected content item is then sent by the decision engine 102 to the web interface 101, to be served to the personal computer of the user (step 307). Finally, the record in the serve log 104 for the content item is updated with the current time, which is the new most recent time the content item was served (step 308).

Methods for selecting the content item in step 306 are now discussed. As noted above, the content item may be selected at random. In alternative embodiments, the content item that is most profitable per impression to the operator of the content server 100 is selected; the content item with associated limitations that most closely fit the derived profile of the user is selected; or the content item with greatest duration since it was last served is selected.

In alternative embodiments, the minimum time period for a content item is determined for particular periods over a day, for example hourly. In such an embodiment, historical data regarding likely variation in available impressions over a day will be used, for example the expected available impressions for each hourly period, and the minimum time period calculated to give the corresponding proportion of required impressions in each hour period. In such embodiments, further aspects of the historical data may be taken into account, such as the particular day of the week or season of the year. Other aspects, such as weather conditions, may be taken into account, if they are available from the historical data.

In further alternative embodiments, the minimum time period for a content item is determined based on aspects of the limitations for the content item. For example, the historical data may indicate how the proportion of impressions varies based on the origin of those impressions (in other words, the country from which the requests originate). A particular campaign can, for example, be assigned a particular country, time zone or similar, and the minimum time periods for the content items for that campaign set according to the expected impressions that will be available for that country, time zone or similar.

In further alternative embodiments, the minimum time period for a content item is recalculated in real time while the content server is in use; in other words, the minimum time period is recalculated based on the remaining impressions required in a particular time period. For example, suppose 1000 impressions are required in a particular hour, giving a minimum time period of 3.6 seconds (assuming no further adjustments are made). If after half an hour only 200 content items have been served, this leaves 800 impressions required in the remaining half hour. The minimum time period will then be recalculated as 2.25 seconds.

In a further alternative embodiment, the web page impressions are provided by a third party system that allows multiple parties to bid for inclusion of a content item in a web page. (In other words, the third party system is a “real-time bidding” system.) The web interface 101 receives offers of impressions from the third party system, and the decision engine 102 makes bids for the impressions via the web interface 101. If a bid is successful, the third party system indicates this by requesting a content item from the web interface 101, which the decision engine 102 selects and sends as desired above. The decision engine 102 can modify the level of bids made based upon a comparison of the number of impressions made so far and the number of impressions required. For example, if 1000 impressions are required in an hour, and after half an hour only 200 content items have been served, this may be due to too few bids for impressions being successful. In this case, the decision engine 102 can increase the level of the bids made, so that more bids are successful giving more impressions for which content items can be served.

Whilst the present invention has been described and illustrated with reference to particular embodiments, it will be appreciated by those of ordinary skill in the art that the invention lends itself to many different variations not specifically illustrated herein.

1. A content server for serving content items for inclusion in a web page, comprising:
a web interface operating on a processor and arranged to receive requests for content items and to transmit content items in response to such requests;
a content store arranged to store a plurality of content items in a nontransitory data memory device, each content item having associated with it a desired number of impressions for a predetermined time period;
a serve log arranged to store, for each content item, the most recent time which it was served by the content server;
a decision engine arranged, in response to a request for content received by the web interface, to transmit a content item from the plurality of content of items via the web interface;
wherein the decision engine is arranged to calculate, for each content item, a minimum time period for the content item based on its associated desired quantity of impressions and the predetermined time period;
and wherein the decision engine is further arranged to select the content item for transmission by the web interface from amongst the content items for which the duration between the current time and the time stored in the serve log exceeds the minimum time period calculated for the content item.

2. A content server as claimed in claim 1, wherein the decision engine is arranged to periodically recalculate the minimum time periods for the content items.

3. A content server as claimed in claim 1, wherein the minimum time periods are calculated for a plurality of intervals in the predetermined time period.

4. A content server as claimed in claim 1, wherein the minimum time periods are calculated based on historical data of available impressions.

5. A content server as claimed in claim 1, wherein the web interface is arranged to obtain data indicating the type of a request for content items, and the content items have associated with them limitations on the types of request for which they will be selected.

6. A content server as claimed in claim 5, wherein the minimum time periods are based on the limitations associated with the content items.

7. A content server as claimed in claim 1, wherein the decision engine is further arranged to select content items for transmission by the web interface from amongst content items with no associated minimum time period.

8. A content server as claimed in claim 1, wherein the plurality of content items includes video clips, and wherein the desired number of impressions associated with the video clips is calculated based on with their duration.

9. A content server as claimed in claim 1, wherein the web interface is arranged to receive offers of impressions from a remote system, the decision engine is arranged to make a bid for an impression via the web interface, and to transmit the selected content item via the web interface when the remote system indicates that the bid has been successful.

10. A method of serving content items for inclusion in a web page from a plurality of items, each content item having associated with it a desired number of impressions for a predetermined time period, comprising the steps of:
for each content item, calculating, with a processor, a minimum time period for the content item based on its associated desired quantity of impressions and the predetermined time period;
in response to a request for a content item, selecting a content item from the plurality of content items using the processor;
serving the selected content item,
recording the time at which the content item was served in a nontransitory data memory device;
wherein the content item is selected from amongst the content items for which the duration between the current time and the recorded time exceeds the minimum time period calculated for the content item.

11. A method as claimed in claim 10, wherein the minimum time period is periodically recalculated.

12. A method as claimed in claim 10, wherein the minimum time periods are calculated for a plurality of intervals in the predetermined time period.

13. A method as claimed in claim 10, wherein the minimum time periods are calculated based on historical data of available impressions.

14. A method as claimed in claim 10, wherein data indicating the type of the request is received with the request, and the content items have associated with them limitations on the types of request for which they will be selected.

15. A method as claimed in claim 14, wherein the minimum time periods are based on the limitations associated with the content items.

16. A method as claimed in claim 10, wherein the content item is further selected from amongst content items with no associated minimum time period.

17. A method as claimed in claim 10, wherein the plurality of content items includes video clips, and wherein the desired number of impressions associated with the video clips is calculated based on their duration.

18. A method as claimed in claim 10, further comprising the steps of:
receiving an offer of an impression from a remote system;
sending a bid for the impression to the remote system.

19. A computer program product arranged, when executed on a server, to provide a content server as claimed in claim 1.

20. A computer program product arranged, when executed, to perform the steps of the method of claim 10.
